(19) United States
(12) Patent Application Publication
(10) Pub. No.: US 2012/0158443 A1
(43) Pub. Date: Jun. 21, 2012

(54) METHOD AND APPARATUS FOR TRANSMITTING TICKET INFORMATION IN PORTABLE TERMINAL

(75) Inventor: Ki-Chan KIM, Gyeongsangbuk-do (KR)

(73) Assignee: SAMSUNG ELECTRONICS CO., LTD., Gyeonggi-Do (KR)

(21) Appl. No.: 13/331,056

(22) Filed: Dec. 20, 2011

(30) Foreign Application Priority Data
Dec. 20, 2010 (KR) 10-2010-0131058

(51) Int. Cl. G06Q 10/02

(52) U.S. Cl. 705/5

(57) ABSTRACT

A method for transmitting ticket information of a portable terminal includes: receiving the ticket information including common information, one or more individual information, and authentication information corresponding to each of the individual information; displaying the ticket information by using the common information and the individual information when a request for transmitting the received ticket information to another terminal is made; making a request for transmitting an area corresponding to a specific individual information in the displayed ticket information; and generating ticket information in identifiable form including common information, a specific individual information, and authentication information corresponding to the specific individual information to transmit the generated information.

### CLAIM OF PRIORITY

This application claims priority under 35 U.S.C. §119(a) to a Korean Patent Application entitled “Method and Apparatus for Transmitting Ticket Information in Portable Terminal” filed in the Korean Intellectual Property Office on Dec. 20, 2010 and assigned Serial No. 10-2010-0131058, the contents of which are incorporated herein by reference.

### BACKGROUND OF THE INVENTION

1. Field of the Invention

The present invention relates to a portable terminal, and more particularly to a method and an apparatus for transmitting ticket information from a portable terminal to another portable terminal.

2. Description of the Related Art

In general, a portable terminal refers to an electronic apparatus providing functions by which a user can perform voice and data communication while roaming. As the mobile communication environments have been diversified and developed, application of the portable terminal is being gradually diversified from a simple voice communication to various fields.

Specifically, a recent portable terminal is now capable of reserving a ticket for a movie or a train by using a Wi-Fi function or an NFC function without the need to reserve the ticket by printing it in a paper.

However, when the ticket reserved through the portable terminal includes reservation details for many users (e.g. friends or families) together, there is no method to distribute the ticket to each of the users. Therefore, the rest of the users included in the reservation details must contact the user who received and stored the reservation ticket in his or her portable terminal, thereby causing inconvenience to the users.

### SUMMARY OF THE INVENTION

Accordingly, the present invention has been made to provide a function of transmitting the ticket information to the plural users included in payment details (or reservation details) to share the ticket information when the payment details (or reservation details) for the plural users are all included in one electronic ticket.

In accordance with an aspect of the present invention, a method for transmitting ticket information in a portable terminal includes: receiving the ticket information including common information, one or more individual information, and authentication information corresponding to each of the individual information; displaying the ticket information by using the common information and the individual information when a request for transmitting a specific individual information from the received ticket information is made; requesting a transmission of an area in the displayed ticket information corresponding to the specific individual information; and generating a new ticket information for transmission including the common information, the specific individual information corresponding to the area, and the authentication information corresponding to the specific individual information and transmitting the generated ticket information.

In accordance with another aspect of the present invention, an apparatus for transmitting ticket information in a portable terminal includes: a memory for storing received ticket information when ticket information including common information, one or more individual information, and authentication information corresponding to the individual information is received; a display unit for displaying the ticket information according to a request for transmitting the received ticket information; and a controller for generating a new ticket information for transmission including the individual information corresponding to an area corresponding to a specific individual information, authentication information corresponding to the specific individual information, and the common information to transmit the generated ticket information for transmission. In accordance with another aspect of the present invention, a method for transmitting ticket information in a portable terminal includes: receiving a ticket information containing reservation details for each of the plural users; displaying the ticket information including common information, one or more individual information, and authentication information corresponding to each of the individual information in response to a request for transmitting the ticket information to another portable terminal; and generating a new ticket information in identifiable form relating to a specific individual information for transmission.

### BRIEF DESCRIPTION OF THE DRAWINGS

FIG. 1 is a block diagram of a portable terminal according to an embodiment of the present invention;

FIG. 2 is a flowchart illustrating a process of transmitting ticket information according to an embodiment of the present invention;

FIG. 3 is a first example illustrating a process of transmitting ticket information according to an embodiment of the present invention;

FIG. 4 is a second example illustrating a process of transmitting ticket information according to an embodiment of the present invention;

FIG. 5 is a third example illustrating a process of transmitting ticket information according to an embodiment of the present invention;

FIG. 6 is a fourth example illustrating a process of transmitting ticket information according to an embodiment of the present invention;

### DETAILED DESCRIPTION OF EXEMPLARY EMBODIMENT

Hereinafter, the embodiments of the present invention will be described with reference to the accompanying drawings.

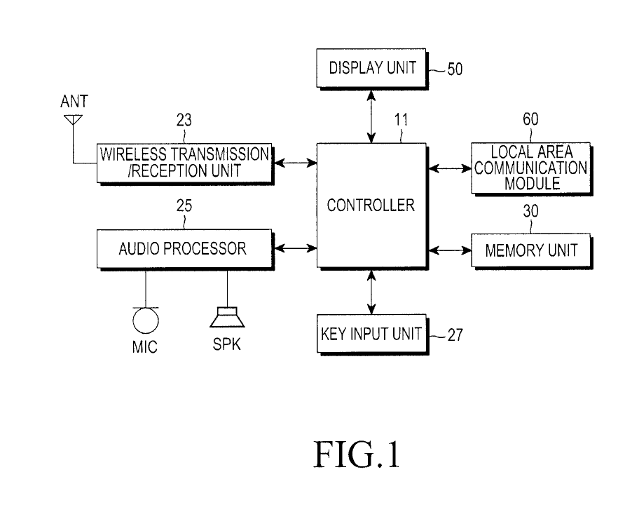

FIG. 1 is a block diagram of the portable terminal according to an embodiment of the present invention. The portable terminal according to an embodiment of the present invention is an electronic apparatus and may include a video phone, a mobile phone, a smart phone, an IMT-2000 (International Mobile Telecommunication 2000) terminal, a WCDMA terminal, a UMTS (Universal Mobile Telecommunication Service) terminal, a PDA (Personal Digital Assistant), a PMP (Potable Multimedia Player), a DMB (Digital Multimedia Broadcasting), a personal computer, a desktop computer, a notebook computer, or a digital camera.

Although apparatuses, which may be included in the portable terminal, such as a GPS (Global Positioning System) module, a camera module, a bluetooth module, an acceleration sensor, a proximity sensor, a geomagnetic sensor, and a DMB (Digital Multimedia Broadcasting) receiver are not illustrated in the block diagram of FIG. 1, it is apparent to a person skilled in the art that the apparatuses may be included in the portable terminal according to an embodiment of the present invention and may provide corresponding functions. For example, the acceleration sensor measures dynamic force such as acceleration, vibration, impact, etc. to sense a movement state of the portable terminal. Through the above function, the acceleration sensor can be used for sensing a display direction of a display unit of the portable terminal. Further, the proximity sensor senses the approach of parts of the body of the user to the portable terminal. The proximity sensor can be used for preventing malfunction of the portable terminal providing a touch screen function. Further, a gyroscope observes a dynamic motion of the portable terminal which rotates. The gyroscope can be used for sensing rotating motions on six axes, which are a vertical axis, a horizontal axis, an anteroposterior axis, an x axis, a y axis, and a z axis, of the portable terminal by interlocking with the acceleration sensor.

Now, the portable terminal according to an embodiment of the present invention will be discussed with reference to FIG. 1 in consideration of the above description.

A wireless transmission/reception unit 23 includes an RF unit and a modem. The RF unit includes an RF transmitter for up-converting and amplifying a frequency of a transmitted signal, and an RF receiver for low noise-amplifying a received signal and down-converting a frequency. The modem includes a transmitter for encoding and modulating a signal to be transmitted and a receiver for demodulating and decoding a signal received by the RF unit.

An audio processor 25 may include a codec, and the codec includes a data codec and an audio codec. The data codec processes packet data, and the audio codec processes audio signals such as voice and multimedia files. The audio processor 25 performs functions of converting a digital audio signal received by the modem to an analog audio signal through the audio codec to reproduce the converted analog audio signal, or converting an analog audio signal generated from a microphone to a digital audio signal through the audio codec to transmit the converted digital audio signal to the modem. The codec may be separately implemented or may be included in the controller 10.

A key input unit 27 may include keys required for inputs of number and character information and function keys required for settings of various keys, a touch pad, etc. When a display unit 50 according to an embodiment of the present is implemented in a touch screen manner, the key input unit 27 may not be included in the portable terminal or may include the minimum number of preset keys. Therefore, the display unit 50 can replace a part of key input functions of the key input unit 27.

A memory 30 may include a program memory and data memories. The program memory stores a program for controlling a general operation of the portable terminal. The memory 30 according to an embodiment of the present invention may include external memories such as a CF (Compact Flash) memory, a SD (Secure Digital) memory, a Micro-SD (Micro Secure Digital) memory, a Mini-SD (Mini Secure Digital) memory, an xD (Extreme Digital) memory, and a memory stick.

The memory 30 according to an embodiment of the present invention stores ticket information including information with regard to the purchased ticket. Here, the stored ticket information may include common information, one or more individual information, and each of authentication information corresponding to the individual information.

In the payment details of the ticket information, the common information refers to information, which the plural users included in the payment details of the ticket information can use in common, whereas the individual information refers to information, by which each of the plural users included in the payment details of the ticket information can be distinguished.

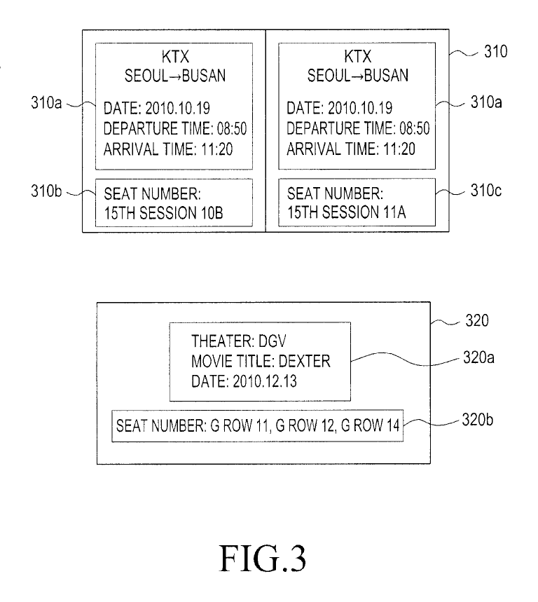

For example, referring to ticket information 310 related to a train ticket reservation as shown in FIG. 3, it is identified that train tickets of two users, which include the same type of trains, the same boarding date, the same departure time, and the same arrival time, but different seat numbers, are reserved. Therefore, the type of trains, the boarding date, the departure time, and the arrival time correspond to the common information in the ticket information 310, and are denoted by reference numeral 310a in FIG. 3. Here, the seat numbers for distinguishing between the two users, as those denoted by reference numerals 310b, etc. in FIG. 3, correspond to the individual information.

Further, referring to ticket information 320 related to a movie ticket reservation as shown in FIG. 3, it is identified that movie tickets of four users, which include the same theater name, the same title of the reserved movie, and the same show date, but different seat numbers, are reserved. Therefore, the theater name, the reserved movie title, and the movie show date, except for the seat numbers, correspond to the common information in the ticket information 320 and are denoted by reference numeral 320a in FIG. 3. Here, since the seat numbers are information for distinguishing each of the four users in reserving the movie tickets, the seat numbers correspond to the individual information and are denoted by reference numeral 320b in FIG. 3.

The ticket information 310 shown in FIG. 3 separately provides the reservation details for each of the plural users within information of one ticket when the payment for the plural users is approved, and the ticket information 320 shown in FIG. 3 integratively provides the reservation details for all the plural users within information of one ticket when the payment for the plural users is approved.

The authentication information corresponds to the individual information and refers to information for authenticating a normal processing of the payment for a person corresponding to the individual information. For example, the authentication information can be information for authenticating a normal processing of the payment for 15^{th} session 10B denoted by reference numeral 310b.

Meanwhile, the common information, the individual information, and the authentication information should be identified by the controller 10. The identification can be implemented in such a manner that the controller 10 generates the common information, the individual information, and the authentication information in an identifiable form in a payment server and then transmits the identifiable information to the portable terminal.

The display unit 50 may include a LCD (Liquid Crystal Display) and OLED (Organic Light Emitting Diodes including a PMOLED or an AMOLED), and outputs various display information generated in the portable terminal. The display unit 50 according to an embodiment of the present invention may include a touch screen to operate as the input unit for controlling the portable terminal with the key input unit 27.

The display unit 50 according to an embodiment of the present invention can display the ticket information received from the payment server (not shown) according to the control of the controller 10 by using the common information, the one or more individual information, and the authentication information after the payment process is completed.

A local area network module 60 is a communication module, which enables local area network communication between portable terminals. The local area network module 60 may be one module of a ZigBee module, a UWB (Ultra Wide Band) module, a Bluetooth module, or a Radio Frequency IDentification (RFID) tag module. Specifically, it is assumed that the local area network module 60 according to an embodiment of the present invention includes an NFC (Near Field Communication) module.

The NFC (Near Field Communication) module is a non-contact local area network module providing 42 Kbps transmission rate in 13.56 MHz frequency band, and provides a function (e.g. peer to peer communication between portable terminals) of exchanging data between portable terminals in a near distance of 10 cm. The NFC may be an extended technology of the radio frequency identification tag, and provide a function as a reader for reading a tag and as a writer for inputting the tag as well as a function as the tag like the radio frequency identification tag. The NFC can be widely used by providing the user of the portable terminal with certain information in a Push form (e.g. transmits product information, travel information, or traffic information) or providing a function as a fastener for controlling an entrance and an exit as well as providing functions for electronic payments such as a transportation card, a credit card, a membership card, and a coupon.

Meanwhile, the ticket information can be received through the wireless transmission/reception unit 23 or the local area communication module 60 in a message form (e.g. SMS, EMS, or MMS). For example, when the ticket information is received through the local area communication module 60 and the local area communication module includes the NFC module, the ticket information can be received through the payment server interlocked with an NFC reader (not shown).

The controller 10 controls a general operation of the portable terminal according to an embodiment of the present invention, and can convert and control the operation of the portable terminal according to a user input inputted through the key input unit 27 or the display unit 50. The controller 10 according to an embodiment of the present invention receives the ticket information, displays the ticket information by using the common information and the individual information included in the ticket information when the transmission for the received ticket information is requested. When the transmission for the displayed ticket information is requested, the controller 10 generates ticket information for transmission from the displayed ticket information to correspond to the transmission request and then transmits the generated ticket information. A detailed operation of the controller 10 according to an embodiment of the present invention will be discussed in the following description.

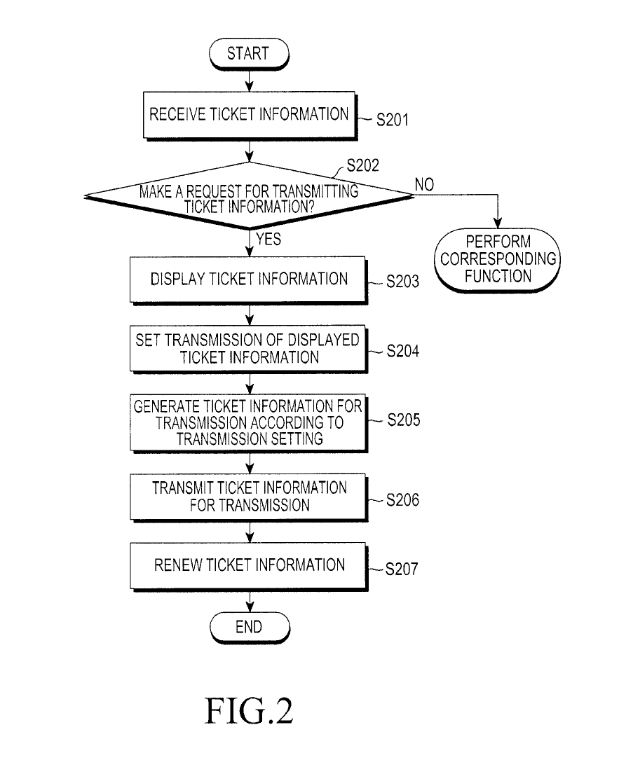

FIG. 2 is a flowchart of a process illustrating a process of transmitting ticket information according to an embodiment of the present invention, and FIGS. 3 to 6 are first to fourth illustrative processes of transmitting ticket information according to embodiments of the present invention.

In steps S201 to S203, the controller 10 receives the ticket information and displays the received ticket information when the transmission for the received ticket information is requested.

The user can obtain ticket information related to the payment details from the payment server after the payment is completed. The user can make a request for transmitting the obtained ticket information to another portable terminal (i.e. user of another portable terminal), and the controller 10 displays the received ticket information in the display unit 50 in response to the request for the transmission.

For example, after completing a train ticket reservation, the user can make a request for displaying the ticket information 310 in the display unit 50 as shown in FIG. 3. In response to the request, the controller 10 identifies the common information, the individual information, and the authentication information corresponding to the individual information from the ticket information. When the identification for the common information, individual information, and the authentication information is completed, the controller 10 displays the ticket information 310 including the common information 310a, and the individual information 310b and 310c in the display unit 50. Note that the description for the ticket information 320 is identical to the description for the ticket information 310. That is, when the transmission for the ticket information related to the movie ticket reservation is requested, the controller 10 displays the ticket information in the display unit 50 using the common information 320a, and the individual information 320b after identifying the common information, the individual information, and the authentication information corresponding to the individual information.

At this time, the authentication information is not separately displayed in the ticket information. Instead, information, which informs that the authentication information is included in the ticket information according to a setting, can be displayed in the ticket information with the common information and the individual information.

The authentication information corresponds to the individual information and refers to information for authenticating a successful(or normal) processing of the payment for a person corresponding to the individual information.

Meanwhile, it is assumed that the identification (distinguishment) for the common information, the individual information, and the authentication information corresponding to each of the individual information by the controller 10 is implemented in such a manner that the controller 10 generates the ticket information in an identifiable form and provides the generated identifiable ticket information.

In steps S204 to S206, the controller 10 is set by the user for a transmission setting with regard to the displayed ticket information, generates the ticket information for transmission according to the transmission setting set by the user, and transmits the generated ticket information for transmission.

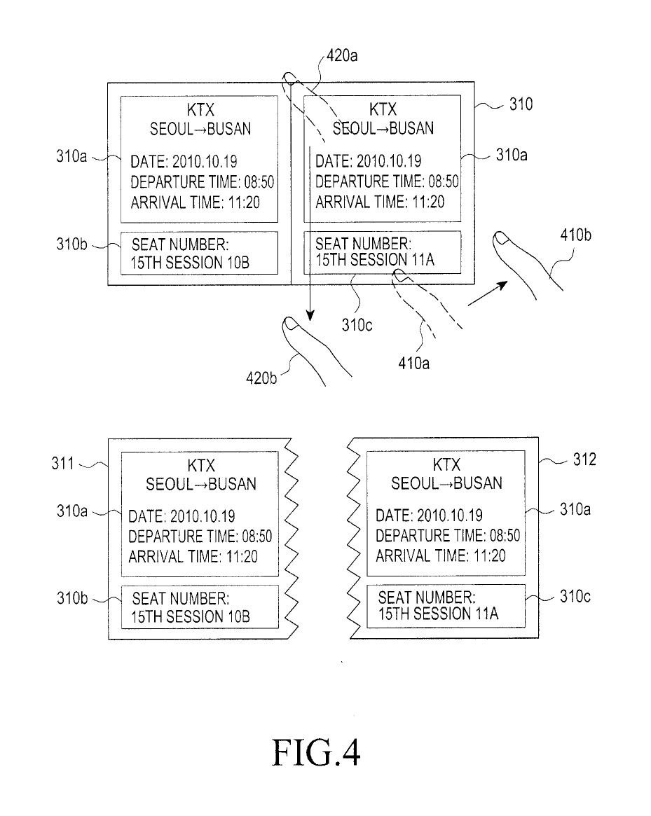

First, the transmission setting in step S204 will be described through an example of the ticket information in which the reservation details (or payment details) for the plural users is separately provided, as the ticket information 310 shown in FIG. 3. The user can make a request for transmitting the ticket information through certain preset inputs 401a to 410b or 420a to 420b shown in FIG. 4.

When touch inputs 410a to 410b (or key input corresponding to the touch input) by a gesture for dividing the individual information 310b and 310c of the ticket information are input as shown in FIG. 4, the controller 10 generates the ticket information 311 and 312 for transmission, transmits the ticket information for transmission selected by the user among the generated ticket information to a contact number set by the user.

When touch inputs 420a to 420b (or key input corresponding to the touch input) by dragging the individual information 310c are input as shown in FIG. 4, the controller 10 divides the ticket information 310 into the ticket information 311 and 312 for transmission and then transmits the ticket information 312 for transmission corresponding to the drag touch input to a contact number set by the user.

Subsequently, the transmission setting in step S204 will be described through an example of the ticket information in which the reservation details for all the plural users is integratively provided within information 320 of one ticket as shown in FIG. 3. The user can make a request for transmitting the ticket information through a certain preset input such as the touch input or a long touch input (or key input corresponding to the touch inputs) for a display area, in which the individual information 320b is displayed, in the ticket information 320 as shown in FIG. 3.

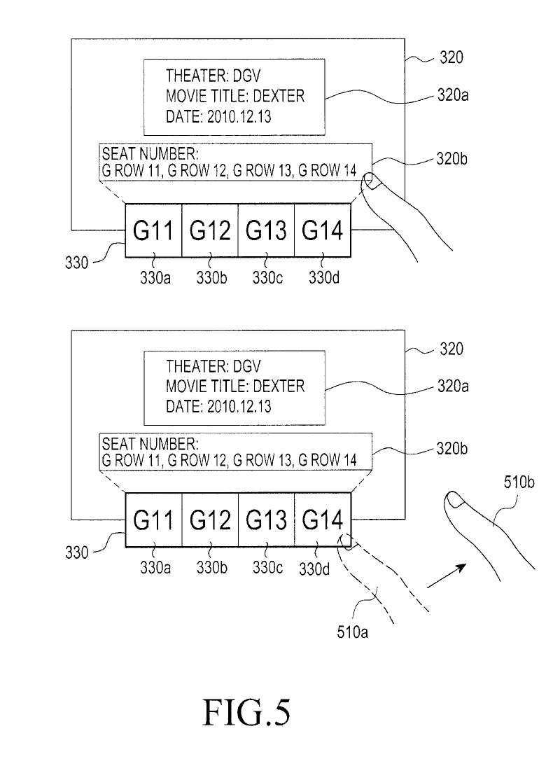

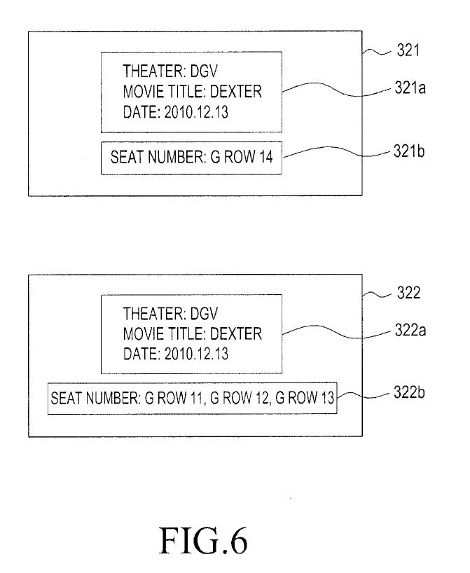

When a certain input for the display area in which the individual information 320b is displayed in the ticket information denoted by reference numeral 320 is input, the controller 10 enlarges the individual information 320b as reference numeral 330 in FIG. 5 and displays the enlarged individual information 320b in the display unit 50. The user makes a request for transmitting individual information (e.g. 330d), which the user desires to transmit among the enlarged and displayed individual information 330, through preset inputs 510a to 510b. In response to the request, the controller 10 generates the ticket information 321 for transmission as shown in FIG. 6 and then transmits the generated ticket information to a contact number set by the user.

Meanwhile, in comparison with the ticket information 310 and 320 in FIGS. 3 to 5, the ticket information 311 or 312 for transmission in FIG. 4 or the ticket information 321 for transmission in FIG. 6 includes the same common information and the different individual information according to the request for transmission of the user. Further, when the controller 10 generates the ticket information for transmission, the controller 10 extracts authentication information corresponding to the individual information included in the ticket information for transmission from the ticket information 310 or 320 and then inserts the extracted authentication information to the generated ticket information for transmission. Therefore, the portable terminal receiving the ticket information for transmission can normally authenticate the received ticket information for transmission to use the ticket information for transmission.

The transmission of the ticket information for transmission from one portable terminal to another portable terminal can be implemented through 3G communication using the wireless transmission/reception unit 23 or through local area communication (preferably, NFC) using the local area communication module 60.

In step S207, the controller 10 renews the ticket information having been received to correspond to the transmission of the ticket information for transmission.

When the controller 10 completes the generation and the transmission of the ticket information for transmission according to the request for transmission of the user, the controller 10 renews the ticket information (which has been received) stored in the portable terminal to correspond to the generation and the transmission of the ticket information for transmission.

For example, when the ticket information 312 for transmission is generated according to the request for transmitting the ticket information by the user and then the generated ticket information for transmission is transmitted, the controller 10 renews or updates the ticket information 310 identically to the ticket information 311 to correspond to the request of the user. That is, the controller 10 includes only the common information 310a, the individual information 310b, and the authentication information corresponding to the individual information 310b in the ticket information by deleting the individual information and the authentication information included in the ticket information 312 from the common information, individual information, and the authentication information included in the ticket information 310.

Further, when the ticket information 321 for transmission in FIG. 6 is generated according to the request for transmitting the ticket information by the user and then the generated ticket information for transmission is transmitted, the controller 10 renews the ticket information 320 identically to the ticket information 322 in FIG. 6 by deleting the individual information 330d and the authentication information corresponding the individual information 330d from the common information, individual information, and the authentication information included in the ticket information 320.

Accordingly, the present invention provides a function of transmitting ticket information including payment details for the plural users together to each of the users to share the ticket information, thereby increasing use of the portable terminal.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been shown and described with reference to certain exemplary embodiments and drawings thereof, it will be understood by those skilled in the art that various changes in form and details may be made therein without departing from the spirit and scope of the invention as defined by the appended claims.

What is claimed is:

1. A method for transmitting ticket information in a portable terminal, the method comprising:
receiving the ticket information including common information, one or more individual information, and authentication information corresponding to each of the individual information;
displaying the received ticket information including the common information and the individual information;
making a request for transmitting an area of the displayed ticket information corresponding to a specific individual information; and
generating a new ticket information in identifiable form for transmission which includes the common information, the specific individual information, and the authentication information corresponding to the specific individual information.

2. The method as claimed in claim 1, wherein, in generating the new ticket information, the specific individual information is separated from other individual information via a manipulation on a display screen.

3. The method as claimed in claim 1, wherein the one or more individual information is enlarged for a selection when generating the new ticket information.

4. The method as claimed in claim 1, wherein making the request comprises:
applying a preset input for the area corresponding to the specific individual information.

5. The method as claimed in claim 4, wherein transmitting the new ticket information for transmission comprises transmitting the new ticket information for transmission to the set portable terminal, to which the ticket information is transmitted.

6. The method as claimed in claim 5, wherein the new ticket information is transmitted by using local area communication.

7. The method as claimed in claim 5, wherein the new ticket information is transmitted by using an NFC (Near Field Communication) module.

8. The method as claimed in claim 1, further comprising updating the received ticket information by deleting the specific individual information and the corresponding authentication information after the transmission.

9. An apparatus for transmitting ticket information in a portable terminal, comprising:
a memory for storing the ticket information including common information, one or more individual information, and authentication information corresponding to the individual information;
a display unit for displaying the ticket information in response to a request for transmitting the ticket information to another portable terminal; and
a controller for generating a new ticket information in identifiable form for transmission including the individual information corresponding to an area corresponding to a specific individual information, the authentication information corresponding to the specific individual information, and the common information when a request for transmitting the area corresponding to the specific individual information in the displayed ticket information is made.

10. The apparatus as claimed in claim 9, wherein, the request for transmitting the area corresponding to the specific individual information is made by inputting a preset input for the area corresponding to the specific individual information.

11. The apparatus as claimed in claim 9, wherein the new ticket information for transmission is transmitted using local area communication.

12. The apparatus as claimed in claim 11, further comprising an NFC (Near Field Communication) module for transmitting the new ticket information for transmission.

13. The apparatus as claimed in claim 9, wherein the controller updates the received ticket information
by deleting the specific individual information and the corresponding authentication information after the transmission.

14. The apparatus as claimed in claim 9, wherein, in generating the new ticket information, the specific individual information is separated from other individual information via a manipulation on a display screen.

15. The apparatus as claimed in claim 9, wherein the one or more individual information is enlarged for a selection when generating the new ticket information.

16. A method for transmitting ticket information in a portable terminal, the method comprising:
receiving a ticket information containing reservation details for each of the plural users;
displaying the ticket information including common information, one or more individual information, and authentication information corresponding to each of the individual information in response to a request for transmitting the ticket information to another portable terminal; and
generating a new ticket information in identifiable form relating to a specific individual information for transmission.

17. The method as claimed in claim 16, further comprising obtaining a payment approval for all the plural users on the one ticket.

18. The method as claimed in claim 16, further comprising updating the ticket information by deleting the specific individual information and the corresponding authentication information after the transmission.

19. The method as claimed in claim 15, wherein, in generating the new ticket information, the specific individual information is separated from other individual information via a manipulation on a display screen.

20. The method as claimed in claim 15, wherein the one or more individual information is enlarged for a selection when generating the new ticket information.
